(19) United States
(12) Patent Application Publication
(10) Pub. No.: US 2012/0250745 A1
(43) Pub. Date: Oct. 4, 2012

(54) SYSTEM AND METHOD FOR RF INTERFERENCE MITIGATION THROUGH MEMORY CLOCK FREQUENCY CONTROL

(75) Inventors: Ian Lockerbie, Calgary (CA); Jared Bruce, Chestermere (CA)

(73) Assignee: NOVATEL WIRELESS, INC., San Diego, CA (US)

(21) Appl. No.: 13/078,702

(22) Filed: Apr. 1, 2011

(51) Int. Cl. H04B 1/10; H04B 1/38

(52) U.S. Cl. 375/222; 375/346

(57) ABSTRACT

Systems and methods are provided to prevent or mitigate noise interference resulting from the operation of a memory device, such as a microSD card that is operating in proximity to a radio of a communications device. Noise interference is managed by shifting the rate at which the microSD card is accessed so that the resulting noise does not match or interfere with the particular radio channel(s) being utilized by radio at the time of the microSD card access. That is, a determination/knowledge of the radio receive channels being utilized can be leveraged to intelligently control the clock frequency of the microSD card, such that the harmonics of the microSD card clock do not result in interfering noise at the particular radio receive frequencies.

### FIELD OF THE INVENTION

The present invention relates generally to portable communication devices, and more particularly, to systems and methods for reducing radio interference from microSD memory devices.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Recently, more and more portable/mobile communication devices have incorporated the use of some type of flash memory to, e.g., expand the native memory of the devices. For example, many wireless telephony devices utilize flash memory in the form of microSD cards that are insertable and removable by a consumer. Uses for such microSD cards include storing multimedia content such as music and picture files, contact information, etc. The microSD card was developed in response to a belief that then-current memory card formats, such as the standard Secure Digital (SD) format, were too large for devices such as mobile telephones.

Additionally, other types of portable communication devices such as external Universal Serial Bus (USB) modems, for example, may also be co-located in the same form factor with microSD cards. That is, USB modems that are connected to, e.g., a laptop computer, via a USB connection may also be provided/integrated with a microSD card slot so that users may utilize a single device for modem purposes as well as for external storage, or even additional functionality implemented in the microSD card.

Most if not all portable communication devices also utilize a radio for the transmission and the receipt of various signals. Oftentimes, noise is emitted during use/accessing of a microSD card, thus creating interference problems with the radio portion of any portable communication device that is configured to operate with a microSD card in a single form factor. For example, such noise interference may make it difficult for a device's radio to receive very feint radio signals.

Historically, interference from noise has been addressed by the use of shields that serve to protect a device/apparatus/wire from external interference. However, and as indicated above, microSD cards are made to be insertable and removable by a user. Because of this characteristic, it is difficult to simply build a shield around the microSD card to reduce or maintain the radio interference at a manageable level. Moreover, the use of some type of physical shield would likely result in the addition of complex componentry.

### SUMMARY OF THE INVENTION

One embodiment of the present invention relates to an apparatus comprising a radio configured to receive signals at a receive frequency. The apparatus further comprises a memory device, operating in proximity to the radio, and configured to operate according to a clock frequency. Further still, the apparatus comprises a controller configured to determine the receive frequency of the radio, and effectuate setting of a clock frequency of the memory device based upon the receive frequency of the radio to avoid interference with the radio during operation of the radio.

Another embodiment of the present invention relates to a method, wherein the method comprises determining a receive frequency of a radio receive channel associated with a radio operating within a communications device. The method further comprises setting a clock frequency of a memory device operating in proximity to the radio based upon the determined frequency associated with the radio to avoid interference with the radio during operation of the radio.

Yet another embodiment of the present invention relates to an apparatus comprising a processor and a memory unit operatively connected to the processor and including a computer program product configured to determine a receive frequency of a radio receive channel associated with a radio operating within a communications device. The computer program product further is further configured to set a clock frequency of a memory device operating in proximity to the radio based upon the determined frequency associated with the radio to avoid interference with the radio during operation of the radio.

In accordance with various embodiments of the present invention, noise interference resulting from the operation of a memory device, such as a microSD card, is managed by shifting the rate at which the microSD card is accessed so that the resulting noise does not match or interfere with the particular radio channel(s) being utilized by radio at the time of the microSD card access. That is, a determination/knowledge of the radio receive channels being utilized can be leveraged to intelligently control the clock frequency of the microSD card, such that the harmonics of the microSD card clock do not result in interfering noise at the particular radio receive frequencies.

These and other advantages and features of various embodiments of the present invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representative illustration of a single form factor device within which various embodiments of the present invention may be implemented;

FIG. 2 is an exemplary high-level schematic representation of the components of the single form factor device of FIG. 1;

FIG. 3 is an exemplary clock supply sequence that may be utilized in accordance with various embodiments of the present invention; and

FIG. 4 is a flow chart illustrating exemplary processes performed in accordance with various embodiments of the present invention to avoid or mitigate interference from a memory device.

### DETAILED DESCRIPTION OF THE PREFERRED EMBODIMENTS

Radio/Radio frequency (RF) modems are RF transceivers for data, and receive and transmit signals from other radio modems. RF modems may be internally or externally mounted. As described above, USB modems are one example of externally mounted radio modems. Current wireless RF modems that cooperatively operate with a host computing device typically include: (1) a radio portion, also called an RF front end or an RF head; (2) a modulator/demodulator portion, also called a baseband processing unit or baseband chip; (3) a central processing unit (CPU) or processor; (4) a memory; and (5) an interface. These modems generally operate using software code to communicate between a user and a base station. The above modem components collectively operate during a wireless communications process to receive an electromagnetic RF signal in a receive mode, wherein the RF signal contains information to be extracted from the received RF signal, and in a transmit mode, wherein the components work collectively to transmit an electromagnetic RF signal, and the RF signal contains the information to be transmitted. Moreover, during receive and transmit modes, the modem components collectively operate to perform three principal modem functions: RF conversion, baseband processing and protocol stack control.

Typically, during RF conversion, the radio receives the RF signal during the receive mode and converts that RF signal into a modulated baseband analog signal and, during the transmit mode, the RF head converts a modulated baseband analog signal into an RF signal for transmission. During baseband processing, the baseband processing unit in the receive mode demodulates the modulated baseband analog signal by extracting a plurality of data bits that correspond to the information being received. In the transmit mode, the baseband processing unit generates the modulated baseband analog signal for processing by the radio.

As part of the above wireless communications process, data bits being transmitted are wrapped with protocol bits of data to facilitate transmission, routing, and receiving of the data bits. Likewise, this protocol data must be removed to accurately reproduce, in the receiving RF modem, the data that was sent. The adding or stripping of the protocol bits, also called protocol stack control, is generally performed by the processor in the RF modem under the control of a protocol stack software program stored in the RF modem's memory. Finally, the interface feeds the data bits from the host computer to the RF modem for processing and transmission, and feeds to the host computer the reproduced data bits that were extracted from the received RF signal.

The host computing device may typically be a laptop or palmtop computer, or a Personnel Digital Assistant (PDA). The host computing device may also be other types of battery powered devices such as a point of sale terminal, a wireless meter reader, a wireless sensor transmitter, or some other computing system. Typical interfaces between the wireless RF modem and the host computer are RS-232, USB as mentioned above, Parallel Port, IrDa, PCMCIA, Flash, Compact Flash, or a low voltage serial interface. However, other interfaces are also used, including a variety of other standard or proprietary interfaces.

Further regarding the radio aspects of RF modems, modems may be configured to operate within certain frequency bands that include, e.g., the 900 MHz, 2.4 GHz, 5 GHz, 23 GHz, Very High Frequency (VHF), and Ultra High Frequency (UHF) ranges. Operating modes for radio modems may include point-to-point, point-to-multipoint, and repeater modes. Point-to-point radio modems can transmit to only one modem/radio modem at a time. Point-to-multipoint modems can transmit to several modems/radio modems at a time.

Radio techniques include direct sequence spread spectrum and frequency hopping spread spectrum, where spread spectrum is used to reduce the impact of localized frequency interferences. To achieve this, it uses more bandwidth than the system needs. There are two main spread spectrum modalities: direct sequence and frequency hopping. The principle of direct sequence spreads the signal on a larger band by multiplexing it with a code (signature) to minimize localized interference and noise. The modem works over a large band. To spread the signal, each bit is modulated by a code. Frequency hopping uses a technique where the signal walks through a set of narrow channels in sequence. The transmission frequency band is divided in certain number of channels, and periodically the modem hops to a new channel, following a predetermined cyclic hopping pattern. The modem avoids interference by never staying in the same channel a long period of time.

Further still, common performance aspects of radio modems include full duplex transmission, maximum output power, number of channels, and sensitivity. Full duplex radio modems can transmit and receive at the same time. Maximum output power is the transmission power of the device, and is defined as the strength of the signals emitted, often measured in mW. The number of channels defines the number of transmitting and receiving channels of the device, while a modem's sensitivity may be measured by the weakest signal that may be reliably sensed by the receiver.

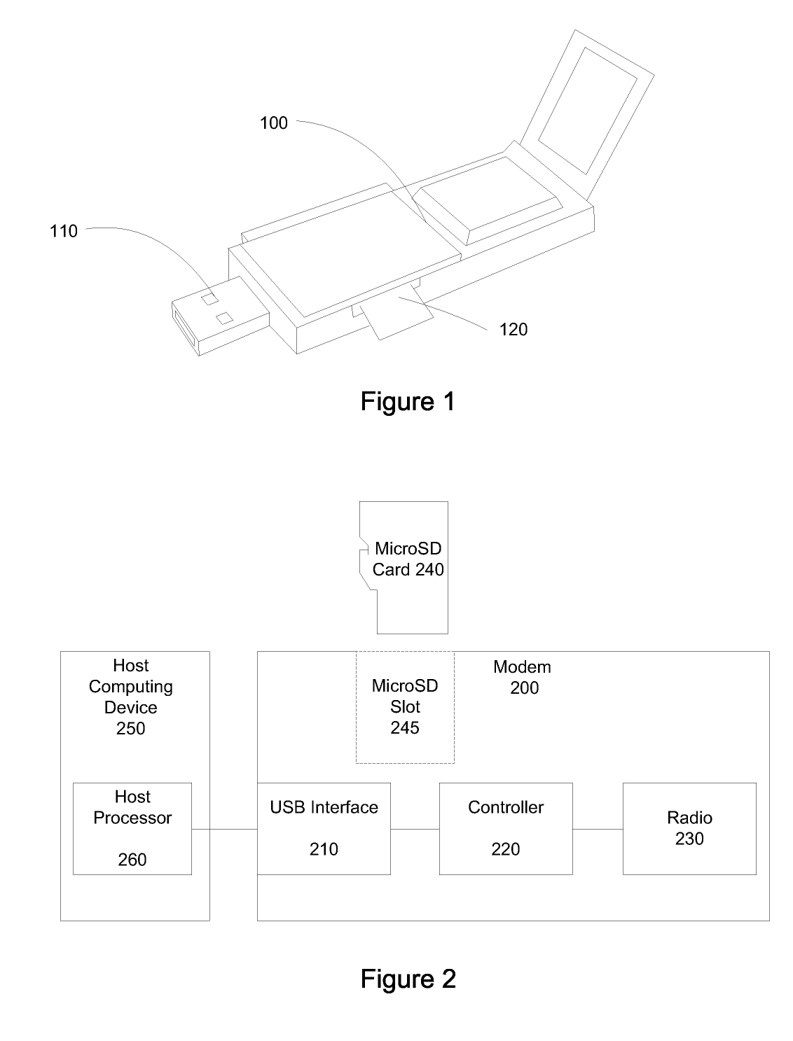

As discussed above, an external modem may be configured to operate in conjunction with a microSD card to, e.g., complement the storage capacity of a host computing device. Therefore, and as illustrated in FIG. 1, a single form factor device, e.g., a USB dongle, may be used to effectuate both an external communication device such as an RF modem, as well as a memory device. The USB dongle 100 may be inserted into a USB port of a host computing device. The USB dongle 100, in part, comprises a USB connector 110 that may be inserted into the USB port of the host computing device. Additionally, a microSD card 120 may be inserted into the USB dongle 100 to effectuate usage of the microSD card 120. It should be noted that the USB and microSD formats are discussed herein merely for exemplary purposes. Various embodiments according to the present invention are not limited to a USB connection nor this flash memory format, but may also be connected in accordance with, e.g., the aforementioned or other interfaces, and applicable to other memory formats, e.g., a CompactFlash format, a standard or mini SD format, etc.

In operation, the USB dongle 100, via, e.g., software, firmware, hardware, or some combination thereof, may be configured to control the modem and microSD functionality. For example, the software, firmware, and/or hardware may be configured to control bus arbitration, memory storage and retrieval, status and message coding/decoding, power usage, interrogation, and signaling. Alternatively, the software, firmware, and/or hardware may instruct the host computing device to control the microSD functionality regarding, e.g., memory storage and retrieval.

FIG. 2 is an exemplary high-level schematic representation of the components of a USB dongle, such as USB dongle 100 of FIG. 1 effectuating RF modem and microSD functionalities when connected to a host computing device. A modem 200 is illustrated as having a USB interface 210 to connect to a host computing device, a controller 220 for controlling either one or both of the functionalities of the modem 200 and/or a microSD card 240 inserted into microSD slot 245. As described above, the controller 200 may be software, firmware, hardware, or some combination thereof. Additionally, the modem 200 further comprises a radio 230. FIG. 2 additionally illustrates a host computing device 250, such as laptop computer, that comprises in part a host processor/controller 260 that interacts via the USB interface 210 with the modem 200 and/or a microSD card 240 inserted into the microSD slot 245. It should be noted that modems contemplated in accordance with various embodiments of the present invention may comprise more than one radio, such as a multi-mode modem.

As also discussed above, interference with the radio portion of a modem can result from the concurrent or simultaneous use of a microSD card. In particular, noise emanating from a microSD card is harmonically related to the rate at which the microSD card is being accessed. Therefore, and in accordance with various embodiments of the present invention, noise interference is managed by shifting the rate at which the microSD card is accessed so that the resulting noise does not match or interfere with the particular radio channel(s) being utilized by the modem at the time of the microSD card access. That is, a determination/knowledge of the radio receive channels being utilized by a modem can be leveraged to intelligently control the clock frequency of the microSD card, such that the harmonics of the microSD card clock do not result in interfering noise at the particular radio receive frequencies.

Host computing devices/drivers with respect to microSD card interaction, are generally designed following the SD host controller specification, such as the “SD Host Controller Simplified Specification Version 2.00,” as defined and set forth by the SD Association, and available at the SD Association website. The SD host controller specification defines a standard register set to control SD memory cards and provides suggested standards to follow for achieving compatibility with the SD card format.

As described above, embodiments of the present application control the access rate of the microSD card based upon one or more radio receive frequencies. In particular, the clock frequency of a microSD card is adjusted/coordinated with the one or more radio receive frequencies, such that any noise interference generated by the microSD card will not fall near a currently-used radio receiver channel.

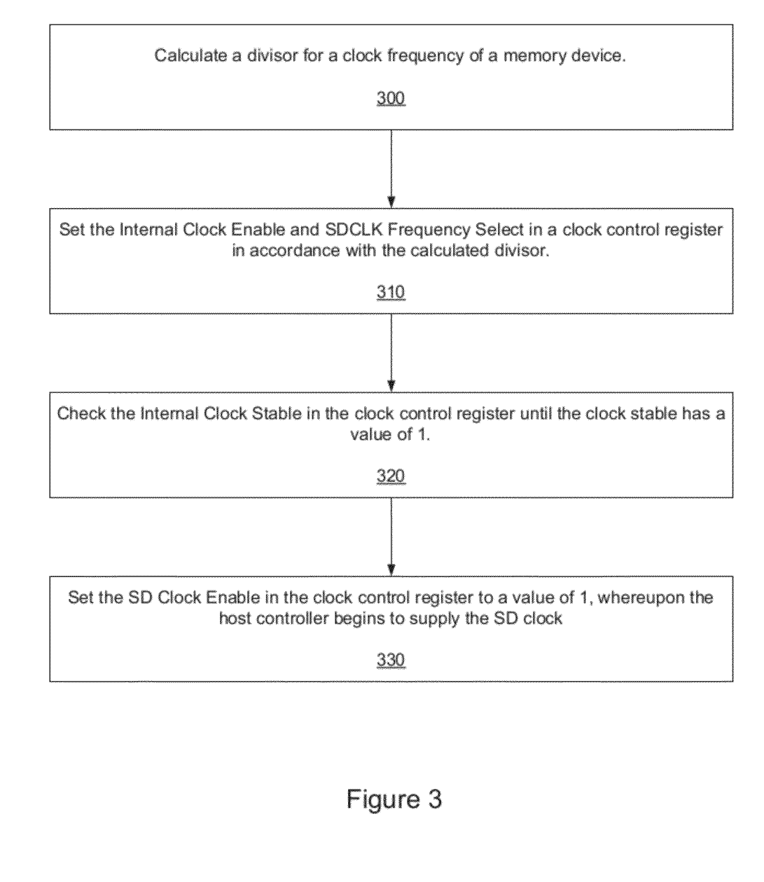

To control the clock frequency of a microSD card, a clock supply sequence is initiated. FIG. 3 illustrates an exemplary clock supply sequence that may be utilized in accordance with various embodiments of the present invention. At block 300, a divisor is calculated for a clock frequency of a memory device, such as a microSD card. At block, 310, the Internal Clock Enable and the SDCLK Frequency Select in the clock control register of the host controller are set in accordance with the calculated divisor. At block 320, the Internal Clock Stable of the clock control register is checked until the clock stable bit has a value of 1. At block 330, the SD Clock Enable bit in the clock control register is set to a value of 1, whereupon the host controller begins to supply the SD clock to the microSD card.

It should be noted that in the context of the present invention and in accordance with certain embodiments, the host controller refers to the modem/USB dongle controller. That is and referring back to FIG. 2, the controller 220 would control the microSD clock frequency by supplying the SD clock to the microSD card as described herein. However, and in accordance with other embodiments of the present invention, a controller of the host computing device (such as host processor 260 illustrated in FIG. 2), may be configured to control the microSD clock frequency. For example, the modem/USB dongle controller may be configured/utilized to instruct the processor of the host computing device in tuning, e.g., a host microSD clock frequency in the event the host computing device itself is experiencing interference issued caused by a microSD card.

In the event that the clock frequency has to be changed, a clock frequency change sequence is initiated. First, the clock is stopped, i.e., by setting the SD Clock enable bit in the clock control register to a value of 0, whereupon the host controller stops supplying the SD clock. Second, once the clock is stopped, a new SD clock is supplied in the manner described above.

Therefore, once a currently-used radio receive frequency is determined, the clock frequency of the microSD card may be initiated or changed accordingly so as to avoid any interference. Determination of the relevant radio receive channel/frequency can be determined, e.g., by the modem controller monitoring the radio, whereupon a message/notification or instruction indicating the relevant radio receive channel/frequency is sent to the host processor of the host computing device. The clock supply or frequency change sequences may be initiated using a calculated divisor for a clock frequency that falls “enough” outside of the radio receive channel/frequency range or is sufficiently distant from the radio receive channel/frequency, to avoid interference therewith.

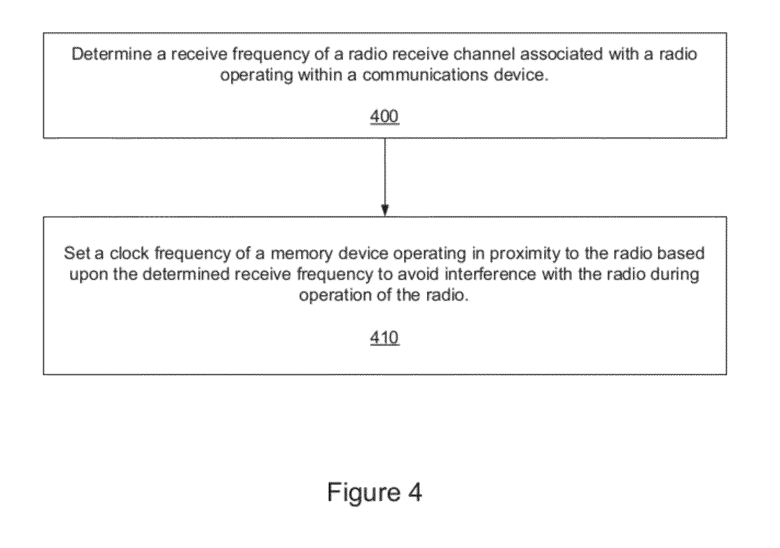

FIG. 4 is a flow chart illustrating exemplary processes performed in accordance with various embodiments of the present invention to avoid interference from a memory device. At block 400, a receive frequency of a radio receive channel associated with a radio operating within a communications device is determined. At block 410, a clock frequency of a memory device operating in proximity to the radio is set based upon the determined receive frequency to avoid interference with the radio during operation of the radio.

The terms “enough,” “avoid,” and “sufficient” as used in the context of interference herein are not necessarily suggestive of an absolute or particular frequency. Rather, avoidance of interference as contemplated by various embodiments of the present invention may be either complete avoidance of interference, or merely managing the interference/mitigating the effects of interference according to desired operating parameters of the radio and/or the communication device.

It should be noted that the aforementioned technique for supplying and/or changing the clock frequency of a microSD card is merely an exemplary method that may be utilized while adhering to the SD Association “SD Host Controller Simplified Specification.” That is, alternative techniques or other techniques used in conjunction with the above method may be utilized to set or alter the clock frequency of a microSD card so as to avoid interference with one or more radios of a modem.

Moreover, various embodiments of the present invention are not limited to single form factor RF modems. The systems and methods described herein may also be applied to other radio devices that operate in conjunction with/proximate to a memory device that may cause interference. For example, the host controller functionality described above could be implemented within, e.g., a processor of a mobile telephone, negating the need for any interface other than the memory device interface.

Further still, it should be noted that in the case of, e.g., multi-mode modems, or other devices utilizing more than one radio, various embodiments of the present invention may take into consideration more than one radio channel/frequency. For example, a multi-mode modem may have incorporated therein two modem devices, e.g., a Wide Area Network (WAN) modem and a Local Area Network (LAN) modem, where the multi-mode modem communicates simultaneously with both WAN and LAN networks. In such a scenario, the clock frequency of a memory device is adjusted so that interference is avoided relative to the radio channels used for communicating with each of the WAN and LAN networks.

Various embodiments of the present invention may be implemented in a system having multiple communication devices that can communicate through one or more networks. The system may comprise any combination of wired or wireless networks such as a mobile telephone network, a wireless Local Area Network (LAN), a Bluetooth personal area network, an Ethernet LAN, a wide area network, the Internet, etc.

Communication devices may include a mobile telephone, a personal digital assistant (PDA), a notebook computer, etc. The communication devices may be located in a mode of transportation such as an automobile.

The communication devices may communicate using various transmission technologies such as Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc.

An electronic device in accordance with embodiments of the present invention may include a display, a keypad for input, a microphone, an ear-piece, a battery, and an antenna. The device may further include radio interface circuitry, codec circuitry, a controller and a memory.

Various embodiments described herein are described in the general context of method steps or processes, which may be implemented in one embodiment by a software program product or component, embodied in a machine-readable medium, including executable instructions, such as program code, executed by entities in networked environments. Generally, program modules may include routines, programs, objects, components, data structures, etc. that perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

Software implementations of various embodiments of the present invention can be accomplished with standard programming techniques with rule-based logic and other logic to accomplish various database searching steps or processes, correlation steps or processes, comparison steps or processes and decision steps or processes.

The foregoing description of various embodiments have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. An apparatus, comprising:
a radio configured to receive signals at a receive frequency;
a memory device, operating in proximity to the radio, configured to operate according to a clock frequency; and
a controller configured to:
determine the receive frequency of the radio; and
effectuate setting of a clock frequency of the memory device based upon the receive frequency of the radio to avoid interference with the radio during operation of the radio.

2. The apparatus of claim 1, wherein the memory device comprises a microSD card.

3. The apparatus of claim 1 further comprising, a second radio configured to receive additional signals at a second receive frequency.

4. The apparatus of claim 3, wherein the controller is further configured to determine the second receive frequency.

5. The apparatus of claim 3, wherein the controller is further configured to effectuate the setting of the clock frequency of the memory device based upon the receive frequency of the radio and the second receive frequency of the second radio to avoid interference with the either the radio or the second radio.

6. The apparatus of claim 1, wherein the apparatus is configured to be operatively connected to a host computing device.

7. The apparatus of claim 6, wherein the setting of the clock frequency of the memory device is effectuated via the controller instructing the host computing device to set the clock frequency of the memory device.

8. The apparatus of claim 1, wherein the setting of the clock frequency of the memory device is effectuated via the controller changing a currently-used clock frequency and supply a new clock frequency.

9. The apparatus of claim 1, wherein the set clock frequency comprises a frequency sufficiently distant from the receive frequency.

10. The apparatus of claim 9, wherein the radio, the controller, and the memory device are implemented in a single physical form factor.

11. The apparatus of claim 1, wherein the radio comprises a modem radio.

12. A method, comprising:
determining a receive frequency of a radio receive channel associated with a radio operating within a communications device; and
setting a clock frequency of a memory device operating in proximity to the radio based upon the determined receive frequency to avoid interference with the radio during operation of the radio.

13. The method of claim 12, wherein the memory device comprises a microSD card.

14. The method of claim 12 further comprising, determining a second receive frequency of a second radio receive channel associated with a second radio operating within the communications device.

15. The method of claim 14 further comprising, setting the clock frequency of the memory device based upon the receive frequency of the radio and the second receive frequency of the second radio to avoid interference with the either the radio or the second radio.

16. The method of claim 12, wherein the setting of the clock frequency of the memory device is effectuated via a controller of the communications device instructing a host computing device connected to the communications device to set the clock frequency of the memory device.

17. The method of claim 12 further comprising, changing a currently-used clock frequency and supply a new clock frequency.

18. The method of claim 12, wherein the set clock frequency comprises a frequency sufficiently distant from the receive frequency.

19. The method of claim 12, wherein the radio comprises a modem radio.

20. An apparatus, comprising:
a processor; and
a memory unit operatively connected to the processor, and including a computer program product configured to:
determine a receive frequency of a radio receive channel associated with a radio operating within the apparatus; and
effectuate setting of a clock frequency of a memory device operating in proximity to the radio based upon the determined receive frequency to avoid interference with the radio during operation of the radio.

21. The apparatus of claim 20, wherein the memory device comprises a microSD card.

22. The apparatus of claim 20 further comprising, a second radio configured to receive additional signals at a second receive frequency.

23. The apparatus of claim 22, wherein the computer program product is further configured to instruct the processor to determine the second receive frequency, and effectuate the setting of the clock frequency of the memory device based upon the receive frequency of the radio and the second receive frequency of the second radio to avoid interference with the either the radio or the second radio.

24. The apparatus of claim 20, wherein the set clock frequency comprises a frequency sufficiently distant from the receive frequency.

25. The apparatus of claim 20, wherein the radio comprises a modem radio.
